(19) United States
(12) Patent Application Publication
(10) Pub. No.: US 2014/0226225 A1
(43) Pub. Date: Aug. 14, 2014

(54) HANDY REAR VIEW MIRROR

(71) Applicant: John A. Suess, Colorado Springs, CO (US)

(72) Inventor: John A. Suess, Colorado Springs, CO (US)

(21) Appl. No.: 14/177,474

(22) Filed: Feb. 11, 2014

Related U.S. Application Data
(60) Provisional application No. 61/763,006, filed on Feb. 11, 2013.

(51) Int. Cl. G02B 7/00

(52) U.S. Cl. CPC G02B 7/002
USPC 359/879

(57) ABSTRACT

A handy rear view mirror device for use by the rider of a bicycle or other personal mobility vehicle comprising a convex reflective mirror integrated with a base component and held in place over the optimum sweet spot triangulated area between the index finger, thumb and wrist of a bare hand or a gloved hand of any size by means of a harness system comprising an elastic cord threaded through holes in the base component to form loops for insertion of the wrist, index finger and thumb of the hand and secured on the back of the hand through cord pulls at the ends of the elastic cord. The device provides a near vibration-less, clear, sharp and accurate rear viewing, and effortless, infinite maneuverability into the most optimal position to focus through an individual's own unique eyesight, leading to less eye strain.

### CROSS REFERENCE TO RELATED APPLICATION

This application claims priority under 35 USC 119(e) to U.S. Provisional Patent Application Ser. No. 61/763,006 filed, Feb. 11, 2013, which is incorporated herein by reference in its entirety.

### FIELD OF THE INVENTION

The present invention is generally related to rear view mirror devices. More particularly, the invention relates to rear view mirrors for use with bicycles, scooters, motor cycles, wheel chairs and other personal mobility vehicles as well as for use by pedestrians such as walkers, hikers, runners and others who want to have a clear rear view of people and vehicles behind them so that they can react to situations to protect themselves.

### BACKGROUND OF THE INVENTION

The use of rearview mirrors on motor vehicles, motorcycles and scooters has been in vogue from the time these vehicles have been in use on the roads and highways all over the world. In general, rear view mirrors are a required and critical appendage to vehicles driven on the roads whether they are side streets or highways in order to visualize the proximity of other vehicles in relation to one's own so that their vehicle can be maneuvered in the right direction to avoid a collision with other vehicles that may be in the way.

The use of rearview mirrors on bicycles is a more recent phenomenon due to the increase in the number of bicycle riders sprouting on the major thoroughfares principally occupied by motor vehicles, trucks, construction vehicles etc., and the potential danger of getting struck by these vehicles unless the rider maneuvers the bicycle out of the way in a timely manner. In the past, the customary way for a bicyclist to check the traffic following him was to sporadically turn the head to one side and look back over the shoulder while riding the cycle and move into an adjacent lane if needed to let the cycle get out of the way of the other vehicle. This practice is no longer considered safe especially when cycling on roads with heavy vehicular traffic and may be a distraction leading to getting hit from the back or from the sides by other vehicles. The bicycles on the market today are not manufactured with built-in rear view mirrors. The critical need to be able to see clearly what is behind them by bicyclists without having to look over their shoulders especially when riding on roads with heavy traffic, has spawned an industry for the manufacture of rear view mirrors of different, shapes, sizes and designs for use with bicycles. Many if not most of these rear view mirrors affix directly to the bicycle frames, more specifically to the handle bars and handle grips of the bicycle. However, the ability to see clearly through these permanently attached rear view mirrors are limited due to the excessive vibrations of these mirrors caused in turn by the un-buffered vibrations transmitted to the handle bars and grips holding the rearview mirrors when the bicycle is being pedaled over the concrete road surface or on a rugged trail.

In an attempt to be creative, some cycling enthusiasts have attempted to attach or integrate rear view type mirrors to articles customarily worn by riders during cycling such as, garments, gloves, helmets, eye glasses etc. However, a majority of these rear view mirrors affixed on to the user's garments, helmets, eye glasses and specialized gloves do not eliminate the bicycle to rear view mirror transmitted vibrations carried through the rider's body, resulting in the fuzzy and distorted images seen through the mirrors. Additional drawbacks specifically encountered with rear view mirrors attached to a helmet, eye glasses and other types of head gear involve difficulty in focusing on the small fixed position mirrors relative to the user's eyes, causing eye strain, vertigo, and mental fatigue. Some of these rear view mirrors which may be precariously hung from wires or plastic hangers in front of the rider's face and eyes can also cause injury to the eyes and the head area in the event of an accident or fall from the bicycle.

Outdoor trails generally used for bicycling, walking, running, hiking and other pedestrian activities have in recent years seen an invasion by mountain bikers and motorized all terrain vehicles (ATV's) posing a danger especially to the pedestrians who are unexpectedly approached from behind by the faster moving vehicles. A rear-view mirror strategically held by the walker, hiker, or runner will provide them with a clear view of what or who is approaching them from behind so that they can move out of the way and avoid getting hit by the faster moving vehicle.

The present invention is a hand-worn rear view mirror device that overcomes the deficiencies in the prior art for a rear view mirror by providing a mirror with less fuzziness and distortion when used for rear viewing while riding a bicycle, other personal mobility vehicles, or while engaged in activities like walking, running, hiking and other sports. The closest prior art to the present invention's rear view mirror device are those affixed to a user's clothing, specifically a glove. U.S. Pat. No. D640446 to Allen shows a triangular shaped mirror sewn into the back side of a glove. U.S. Pat. No. 8,083,360 to Bartlett describes a hand-held mirror attached to a piece of clothing or other article such as a glove or strap worn around the hand or lower wrist of a user and in some embodiments accompanied by a watch, temperature gauge, altimeter, cell phone, GPS, radio, heart rate monitor, mapping device, or turn signal indicator. U.S. Pat. No. 5,530,588 to Vivier particularly intended for divers, describes a rear view device having a convex dome coated with a light reflecting material placed on top of a glove using Velcro®, or by cutting a slit in the glove and sliding the plate of the dome under the strips of the glove which lies between the slits to hold the dome in place. U.S. Pat. No. 4,863,239 to Malone describes a flat or convex-shaped mirror attached to a dove by conventional methods such as through a hook and loop fastener, adhesive tape or glue, heat melt glue, or by sewing directly on to the outer layer of the glove. In, the rear view mirror device described in U.S. Pat. No. 3,717,403 to Messier, the base of the device is provided with apertures so that it may be sewed or buttoned to the upper surface of a mitten. The rear view mirror device of the present invention can be distinguished from these prior art rear view mirror devices through its many features that don't require the device to be physically sewn, glued, or attached by other means to gloves worn by the rider of a bicycle, other personal mobility vehicle, or worn on the hands of a pedestrian, walker, runner, hiker, or those engaged in other sports.

Prior art involving attaching a rear view mirror device to the body of a bicycle rider are those described in U.S. Pat. No. 6,120,157 to Westover and U.S. Pat. No. 4,054,375 to Ribeca. The device in Westover comprises a viewing apparatus with a convex reflective surface that can be mounted on a user's finger to enable the user to see objects behind them. Such a device when attached to the finger would be an encumbrance to the rider who has to have his fingers gripping the handle bars of the cycle. U.S. Pat. No. 4,054,375 to Ribeca describes a rear view cycling mirror adapted for strapping around the wrist of a user or attached via a clip to the bicycle. The rear view mirror device of the present invention is distinguishable and can be differentiated from these prior art through the summary of the invention, the detailed description of the invention accompanied by the drawings and the claims.

### SUMMARY OF THE INVENTION

The present invention is a rear view mirror device for use with a bicycle, scooter, motorcycle, or other personal transportation vehicles such as, but not limited to the Segway® transporter, motorized handicap transporters and similar personal use vehicles which require a rider to monitor the vehicles behind them in order to quickly move out of the way of other vehicles if needed by switching lanes or moving to the side to avoid a collision with the other vehicle (s). The rear view mirror device of the present invention is specifically designed and constructed to be worn securely over the hand of a rider of a bicycle, or other personal mobility vehicle and provides a steady clear view of the other vehicles that are behind or in close proximity to the rider while on a paved road or even cycling on rugged trails. The rear view mirror device of the present invention can also be used by pedestrians, such as walkers, runners, hikers and others who have to keep an eye on what or who is behind them while engaged in their activities so that they can avoid getting hit from behind by fast moving vehicles traveling on the same path.

The primary object of the present invention is to provide a rear view mirror device for use with bicycles and other personal mobility vehicles that significantly reduces the fuzziness and distortion in viewing caused by vibrations of the bicycle or other personal mobility vehicle when driven on both smooth and rough roads and a rear view mirror that provides easy auto reflex focus and less eye strain for the user of the device.

Another object of the present invention is to provide a rear view mirror device that is compact, light weight, rugged and is capable of easily slipping over the bare hands or gloved hands of a rider whether on a bicycle or personal mobility vehicle.

In the exemplary embodiment of the rear view mirror device of the present invention, the device comprises of a one size fits all adjustable cord harness system with an integrated rear view reflective mirror element. In this embodiment, the integrated convex rear view mirror is securely positioned flat against the back side of a user's bare or gloved hand in the optimum sweet spot triangulated area between the index finger, thumb and wrist. This triangulated area on the back side of the hand is the ideal spot to place the rear view mirror because it provides a steady surface least affected by vibrations transmitted to the hands through the bicycle handle as well as vibrations traveling down the hand from the body while pedaling the bicycle on both smooth and rough surfaces. The other advantage of positioning the rear view mirror on the triangulated area on the back of the hand is the ease with which the hand and the rear view mirror strapped to the hand can be maneuvered into the line of vision of the rider and the ability to continuously adjust the distance between the rear view mirror and the rider's eyes for a clear and steady view of vehicles behind them.

In the exemplary embodiment of the rear view mirror device of the present invention, the manner of using the device is by first slipping the hand, if the left hand through the bottom lower loop created by the elastic elongated cording of the device so that the two sides of the cord are held over the wrist on the back of the hand, then slipping the top left side loop protruding from the upper part of the base section holding the convex mirror over the index finger and the top right side loop over the thumb and positioning the integrated and adjustable mirror element securely in place over the back of the hands. If the rear view mirror device is used on the right hand, the top left side loop would go over the thumb and the top right side loop would be placed over the index finger. Once the device is properly placed in this manner over the user's hands, the one handed, adjustable, tightening and loosening cinch in the form of a cord lock secures the entire device to the users hands. The user is then able to maneuver their hand with the rear view mirror device in place to infinite positions including the most coverable and useable positions needed for optimum rear viewing that best suits the user's eyesight.

The primary features of all embodiments of the rear view mirror device of the present invention are, 1) Gives the rider/user of the device near vibration-less, clear, accurate rear viewing, 2) Effortless, infinite maneuverability into the most optimal position to rapidly focus through for an individual's own unique eyesight, 3) Feels natural and instinctively easy to use, just as raising or moving a hand to signal a turn, 4) Simple one-handed installation, 5) Versatile one-size-fits-all design, 6) Completely adjustable to repeatedly resize for a custom fit on most if not all hand sizes, or glove sizes if a glove is worn over the hand, 7) Can be worn independently on bare hands or over a gloved hand, 8) Does not require the use of helmets, goggle, or other specialty cycling accessories to hold the device, 9) Safer to use because of its quick maneuverability to focus through and refocus back on the path ahead, eliminates eye fatigue and dizziness when trying to focus, avoids potential accidents form swerving while cycling or stumbling and tripping while running and hiking since there is no need to twist around to see what is behind, and 10) Avoids the potential danger encountered with rear view mirror devices fixed to the rider's head area or parts protruding from the bike.

The exemplary embodiment of the rear view device of the present invention uses elastic cording, proprietary channeled base component with affixed convex mirror used to integrate the cording through the base component creating a three cord loop hand harness system outside the base and an adjustable cord clamp and cord ends to tighten and secure the device into position on any users unique size bare or gloved hand. This embodiment of the invention is subject to modification to optimize mass manufacturing and production expenses and may be produced in a variety of colors, replaceable interchangeable reflective mirror elements, new clasping mechanisms and accoutrements to enhance the device's performance and aesthetic appeal.

It should be understood and obvious to one skilled in the art that the exemplary embodiment of the rear view mirror device thus described in this summary of the invention may be further modified without departing from the spirit and scope of the invention.

The objects, features and embodiments of the present invention as described in this summary of the invention will be further appreciated and will become obvious to one skilled in the art when viewed in conjunction with the accompanying drawings, detailed description of the invention, and the appended claims.

### BRIEF DESCRIPTION OF THE DRAWINGS

FIG. 1 is a perspective view of the exemplary embodiment of the present invention.

FIG. 2 is an exploded view illustrating the main components of the present invention.

FIG. 3 is a perspective isometric view of the base component of the present invention.

FIG. 4 is an elevation view from the top of the base component of the present invention.

FIG. 5 is an elevation view of the bottom of the base component of the present invention.

FIG. 6 is a front elevation view of the base component of the present invention.

FIG. 7 is a perspective view of the back side of the base component of the present invention.

FIG. 8 is a perspective view of the left side of the base component of the present invention.

FIG. 9 is a perspective view of the right side of the base component of the present invention.

FIG. 10 is a cross sectional view of the base component of the present invention.

FIG. 11 is a perspective view of the rear view mirror device of the present invention worn over the bare hands of a user.

FIG. 12 is a perspective view of the rear view mirror device of the present invention worn over the gloved hands of a user.

### DETAILED DESCRIPTION OF THE INVENTION

The present invention is a handy rear view mirror device for use with personal mobility vehicles such as bicycles, scooter's, and other motorized and non-motorized vehicles when they are on the roads having both light and heavy traffic so that the riders of the vehicles can have a clear, unobstructed view of other vehicles behind them and take the necessary action to avoid a collision with other vehicles. Unlike other rear view mirror devices on the market and in the prior art, the rear view device of the present invention does not need to be attached to the handle or any other part of the bicycles or personal mobility vehicle, nor placed on a helmet, eyewear, or garments including sewn on to gloves worn by the user of the device. The rear view mirror device of the present invention provides sharp vibration-free clear vision on roads or trails with natural hand to eye stabilization, instant focus is created by the body's natural tendency to automatically adjust at a perfect distance to one's eye sight. The rear view mirror device of the present invention can also be used conveniently by pedestrians such as walkers, runners, hikers and others engaged in various sports that necessitate periodic rear viewing of people and vehicles behind them to avoid a collision and injury to themselves

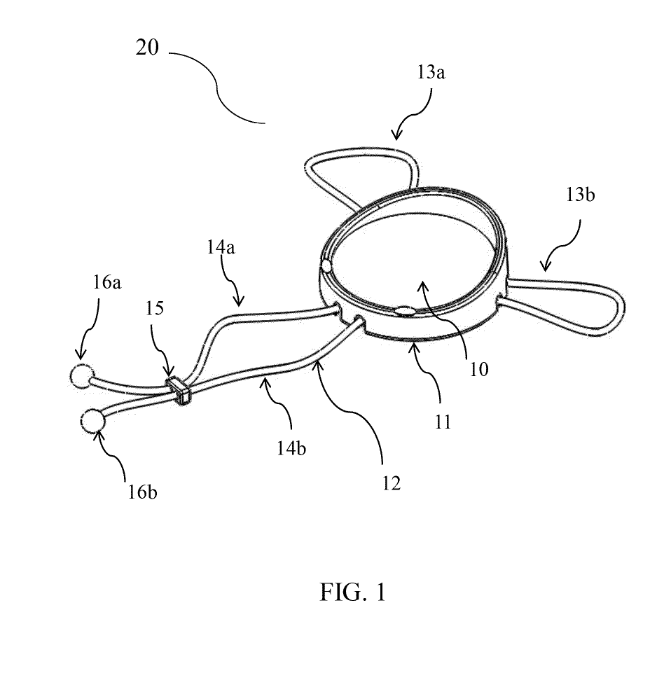

Referring now to the drawings, in which like numerals represent like components in the several views presented and discussed, a perspective view of the exemplary embodiment of the rear view mirror device 20 of the present invention is illustrated in FIG. 1. The rear view mirror device 20 comprises of a convex reflective mirror 10 having wide angle optic properties. The convex reflective mirror 10 is integrated inside a base component 11 which holds and protects the mirror from getting scratched and also shadows the mirror from sun glare when the mirror is being used. The underside of the convex reflective mirror 10 is attached to the base component 11 by means of adhesives or other integrated techniques so that the convex reflective mirror 10 is held securely in place within the base component 11. A cord harness system comprising a single elastic cord 12 is threaded through holes in the base component 11 to form two loops, a finger harness loop 13a for the index finger and a thumb harness loop 13b for the thumb. If the device is worn on the right hand, the finger harness loop 13a is worn over the thumb and the thumb harness loop 13b is worn over the index finger. The elastic cord 12 forms two elongated cord sections 14a and 14b at the lower end of the device. A cord lock 15 holds together and locks the two elongated cord sections 14a and 14b approximately two thirds of the way down the length of the two sections to form a wrist harness loop that will allow the wrist of a hand to be inserted through it. The cord lock 15 can be slid up and down the length of the two elongated cord sections 14a and 14b to tighten or loosen the hold of the cord harness system over the wrist and the back of the hand holding the base component 11 and the integrated convex reflective mirror 10 so that the convex reflective mirror 10 is held in the optimum position on the back of a bare hand or over a gloved hand for clear rear viewing. There are two cord end pull components 16a and 16b placed at the ends of the elongated cord sections 14a and 14b to facilitate the pulling and adjusting of the cord 12 around the index finger through the finger harness loop 13a, around the thumb through the thumb harness loop 13b and around the wrist of the hand through the elongated cord sections 14a and 14b. The cord pull components 16a and 16b also provide the additional benefit of preventing the cord 12 ends from fraying.

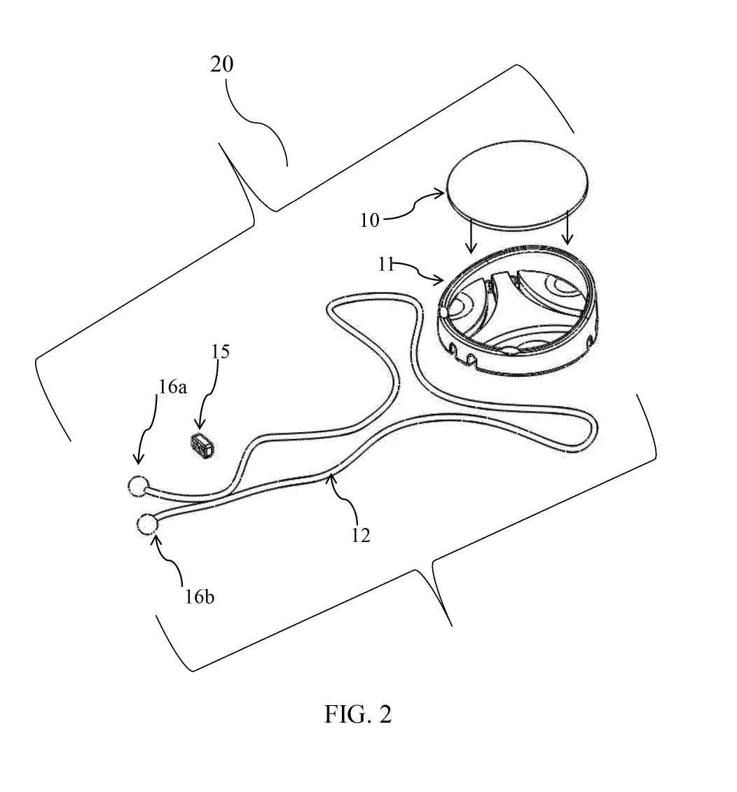

Referring now to FIG. 2 an exploded view of the main components of the handy rear view mirror device 20 is illustrated with the convex reflective mirror 10 shown in relief over the base component 11. Further in this view is shown the single elastic cord 12 separated from the base component 11 and the cord lock 15 separated from the single elastic cord 12. The view also shows the cord end pull components 16a and 16b placed at the two ends of the single elastic cord 12.

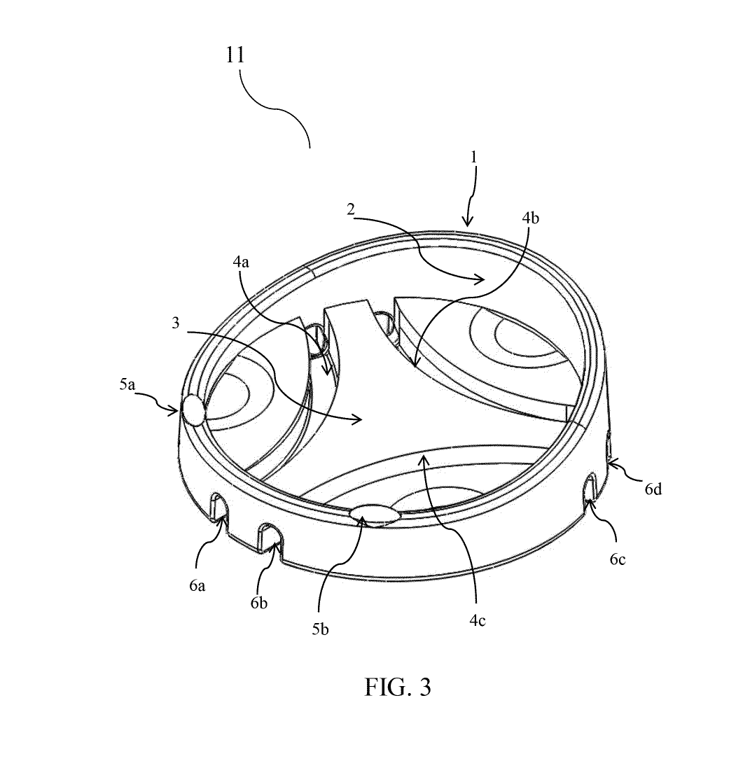

FIG. 3 is a perspective isometric view of the base component 11 with a detailed view of the various structures within the interior well space which is used to hold the convex reflective rear view mirror of the device. The base component 11 has an outer perimeter rim 2 with a high side 1 that slopes downwardly to the base of the rim. There are two bumpy feet 5a and 5b located at the end of the slope of the outer perimeter rim 2. These bumpy feet 5a and 5b help protect the convex reflective mirror after assembly of the device and during the use of the device. The interior well space of the base component has a triangular-shaped platform 3. A set of recessed cord channels 4a, 4b and 4c on the perimeter of the platform 3 are used to hold the elastic cord in place after it is inserted through the port holes 6a, 6b, 6c, 6d, 6e and 6f.

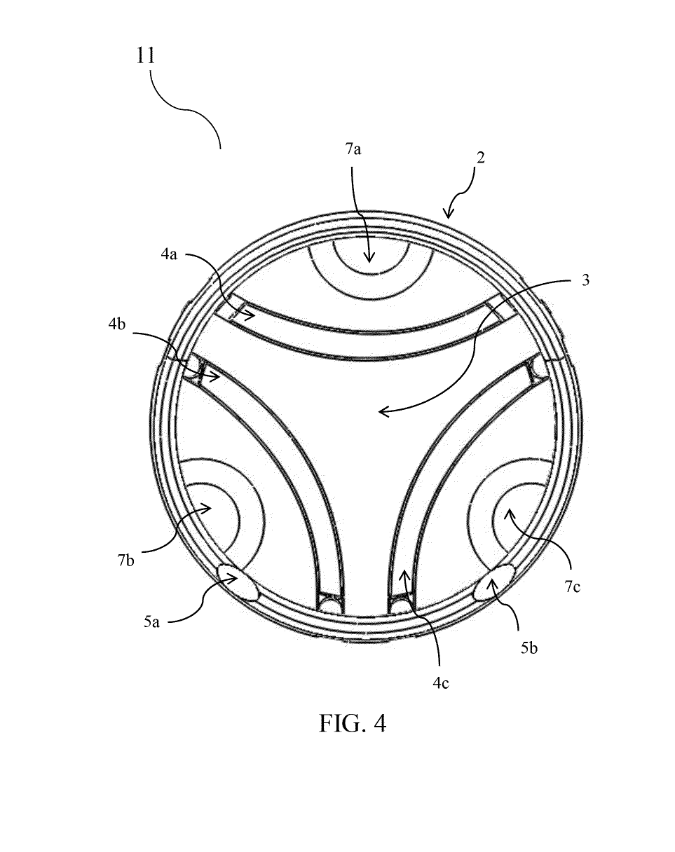

FIG. 4 is an elevation view from the top of the base component 11 of the present invention. In this view, the recessed cord channels 4a, 4b and 4c can be more clearly seen lying around the perimeter of the triangular-shaped platform 3. Three depressed adhesive reservoirs 7a, 7b and 7c lie beyond the recessed cord channels 4a, 4b and 4c close to the outer perimeter rim 2. The bumpy feet 5a and 5b are located at the bottom sloped area of the outer perimeter rim 2.

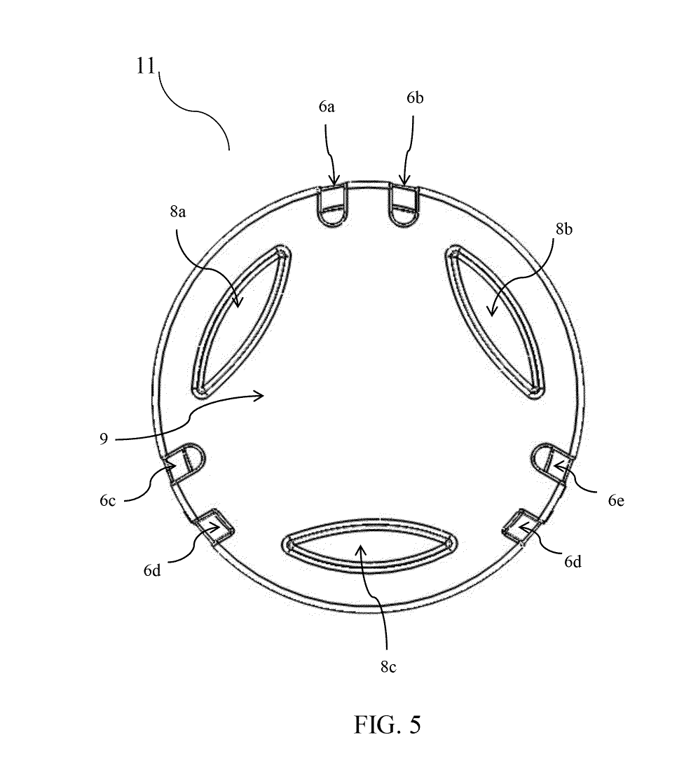

FIG. 5 is an elevation view of the bottom of the base component 11 of the present invention. This view illustrates the recessed wells 8a, 8b and 8c at the bottom of the base component 11. These recessed wells add to the overall rigidity of the base component 11. This view also illustrates more clearly the port holes 6a, 6b, 6c, 6d, fie and 6f for the ingress and egress of the elastic cord of the present invention.

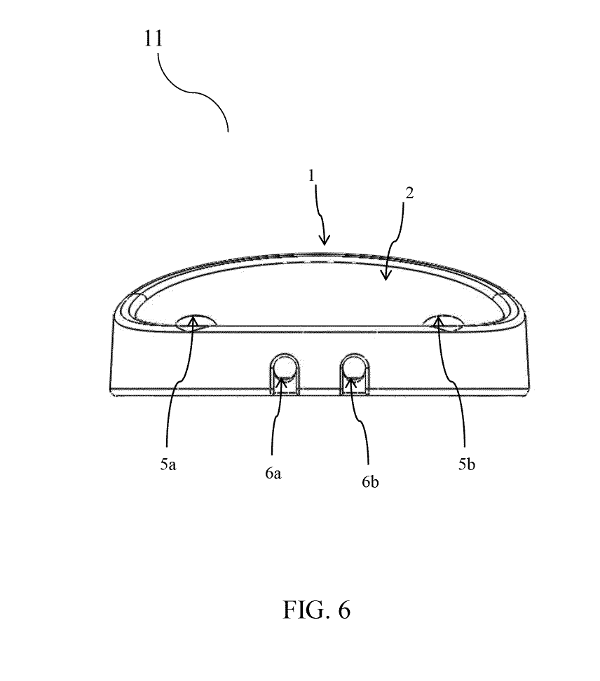

FIG. 6 is a front elevation view of the base component 11 of the present invention. The view shows the high side 1 of the outer perimeter rim 2 with the bumpy feet 5a and 5b located in the downward sloped area of the outer perimeter rim 2. Two of the six port holes 6a and fib through which the elastic cord ingresses and egresses can also be seen in this view.

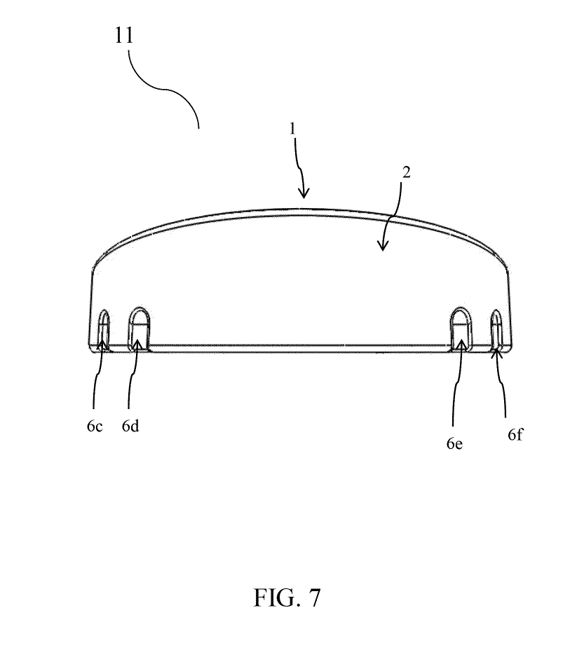

FIG. 7 is a perspective view of the back side of the base component 11 of the present invention showing the high side 1 of the outer perimeter rim 2 and four of the six port holes, 6c, 6d, 6e and 6f through which the elastic cord would be ingresses and egresses.

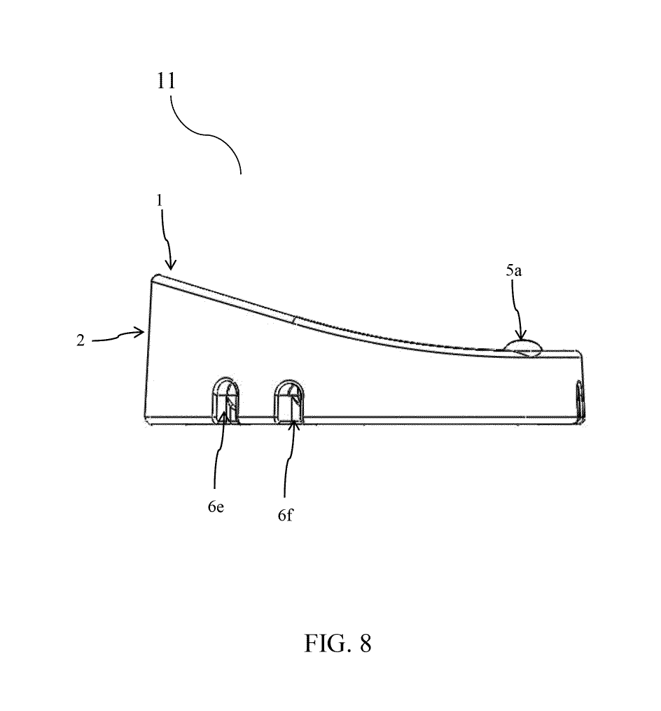

FIG. 8 is a perspective view of the left side of the base component 11 of the present invention illustrating the high side 1 of the outer perimeter rim 2, the port holes 6e and 6f and the bumpy feet 5a situated at the lower end of the outer perimeter rim 2 slope.

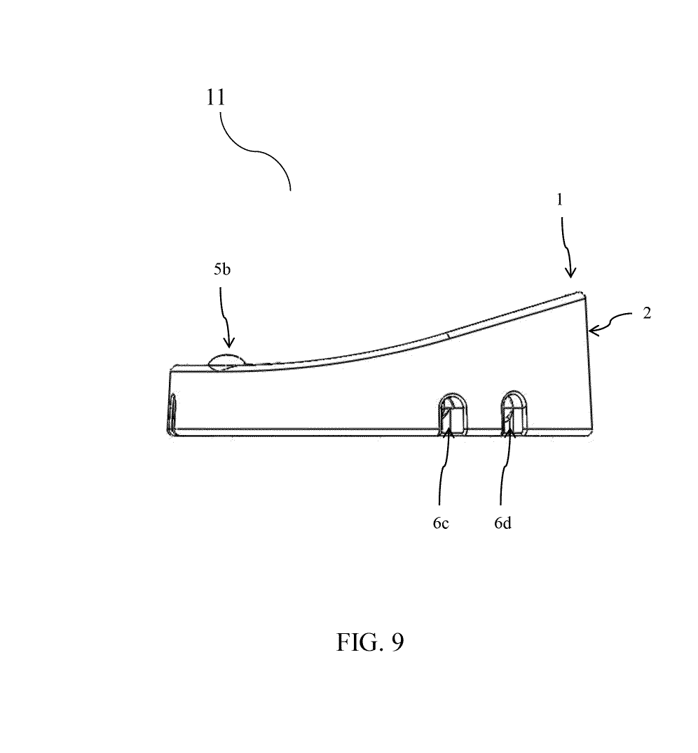

FIG. 9 is a perspective view of the right side of the base component 11 of the present invention illustrating the high side 1 of the outer perimeter rim 2, the port holes 6c and 6d and the bumpy feet 5b situated at the lower end of the outer perimeter rim 2 slope.

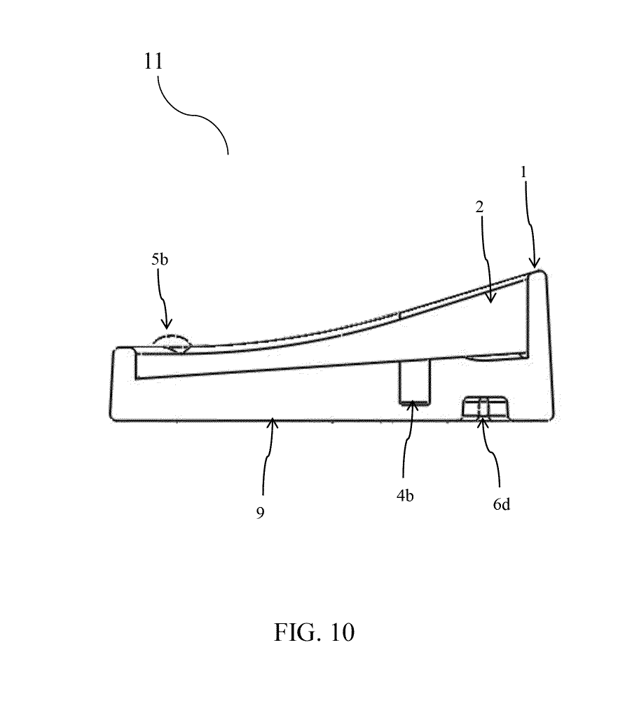

FIG. 10 is a cross sectional view of the base component 11 of the present invention illustrating the cross sections of the interior base wall of the high side 1 of the outer perimeter rim 2, the bumpy feet 5b, the recessed canal 4b, the port hole 6d and the bottom 9 of the base component 11.

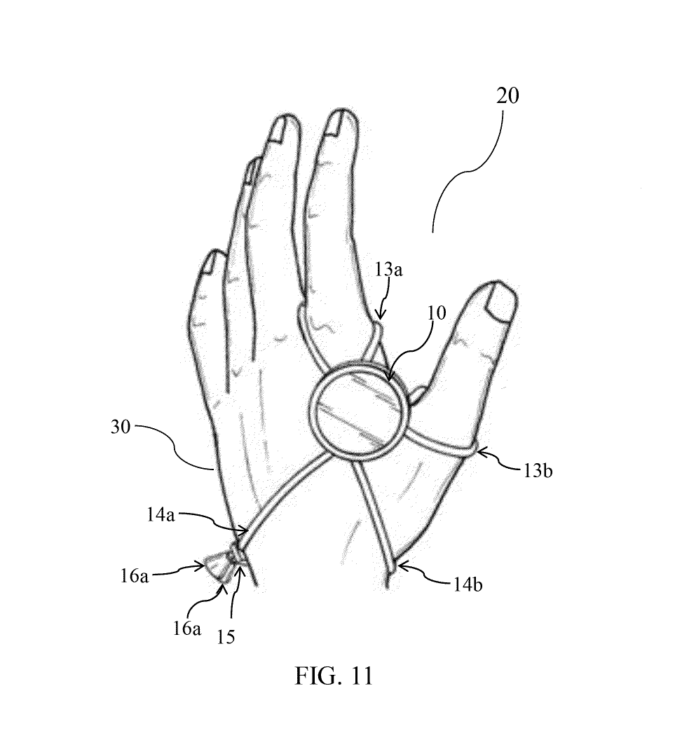

FIG. 11 is a perspective view of the handy rear view mirror device 20 of the present invention worn over the bare hands 30 of a user. With the convex reflective mirror 10 facing upward, the user of the device slips his hand and wrist through the loop created by the elongated cord sections 14a and 14b and the cord lock 15. The user then inserts his index finger through the finger harness loop 13a and the thumb through the thumb harness loop 13b and pulls on the lower end of the cord sections 14a and 14b using the cord pull components 16a and 16b to tighten the device around the wrist.

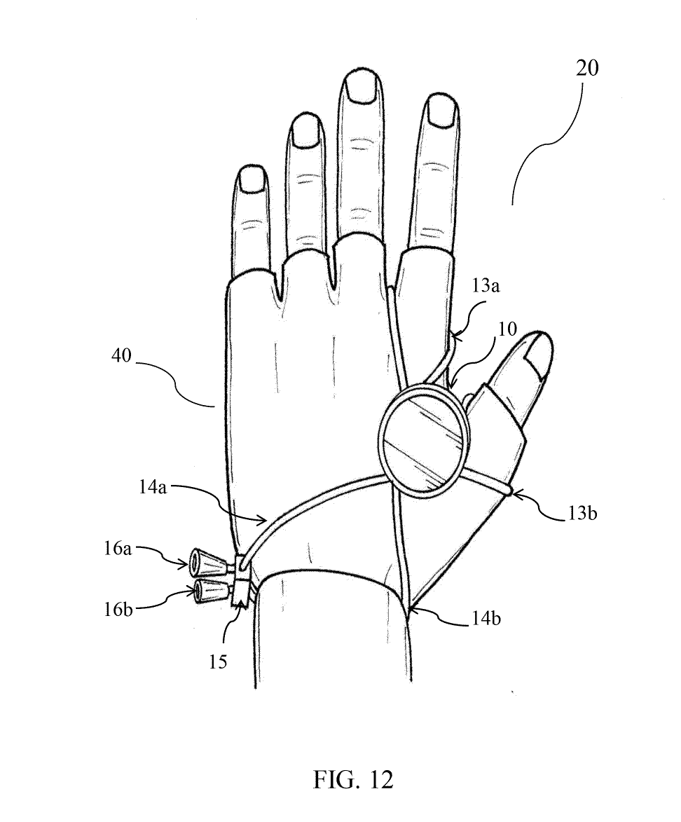

FIG. 12 is a perspective view of the handy rear view mirror device of the present invention worn over the gloved hands 40 of a user. The manner of wearing the device over gloved hand is similar to what has been described for a bare hand in FIG. 11. With the convex reflective mirror 10 facing upward, the user of the device slips his gloved hand and wrist through the loop created by the elongated cord sections 14a and 14b and the cord lock 15. The user then inserts his gloved index finger through the finger harness loop 13a and the gloved thumb through the thumb harness loop 13b and pulls on the lower end of the cord sections 14a and 14b using the cord pull components 16a and 16b to tighten the device around the wrist.

The foregoing description of the exemplary embodiment of the present invention of a handy rear view device for use by a bicycle or other personal mobility vehicle rider and illustrated through the various views of the drawings of the device and detailed explanation of each part that forms the whole of the device should not be construed to limit the scope of the invention. It is to be understood that the embodiment of the present invention as described herein do not limit any application or scope of the invention and that the invention can be carried out and practiced in various ways and implemented in embodiments other than the one outlined in the description above. It is to be further understood that the phraseology and terminology used to describe the invention are for descriptive purposes only. It should be understood and obvious to one skilled in the art that alternatives, modifications, and variations of the embodiment of the present invention may be construed as being within the spirit and scope of the appended claims.

What is claimed is:

1. An apparatus for rear viewing comprising:
a base structure member;
said base structure member having a set of channels;
said base structure member having a set of cord ingress and egress ports;
said base structure member having a set of depressed adhesive reservoirs;
said base structure member having a set of recessed wells at the bottom surface of said base structure member to add rigidity and reinforcement to said base structure member;
a mirror member;
said mirror member having a convex reflective upper surface;
said mirror member having a bottom surface to hold adhesive;
said bottom surface of said mirror member holding said adhesive placed over said depressed adhesive reservoirs in the said base structure member to hold the said mirror member securely in place in a press fit relationship on the said base structure member;
a flexible, elastic cord member with a first and second end;
said flexible elastic cord member threaded through said cord ingress and egress ports on the base structure member to form a wrist harness loop, an index finger harness loop and a thumb harness loop;
a cord lock structure member;
said cord lock structure member used to tighten and loosen said wrist harness loop, said index finger harness loop, and said thumb harness loop to secure the said base structure member holding the said mirror member on the back side of the hand of a user member;
a set of cord pull members on said first end and said second end of said flexible, elastic cord member to pull the said cord member to tighten or loosen around the wrist of a user and prevent the said cord member ends from fraying and pulling out of said cord lock; and
a set of bump feet placed on the lower rim of said base structure member to protect the said mirror member during use of said apparatus for rear viewing.

2. The apparatus for rear viewing as described in claim 1 wherein said base structure member is circular in shape having a raised rim on the top end and a recessed rim at the bottom end.

3. The apparatus as in claim 1 wherein said wrist harness loop is inserted over the wrist of the bare left hand of a bicycle rider, other personal mobility vehicle rider, or a pedestrian such as a walker, runner, hiker, said index finger harness loop inserted over the index finger, said thumb harness loop inserted over the thumb and the said flexible elastic cord member tightened over the wrist of the bare hand of the user to hold the said base structure member and the mirror member with the convex reflective upper surface flat on the back of the bare hand of the user over the optimum sweet spot triangulated area between the index finger, thumb and wrist of the hand.

4. The apparatus as in claim 1 wherein said wrist harness loop is inserted over the wrist of the bare right hand of a bicycle rider, other personal mobility vehicle rider, or a pedestrian such as a walker, runner, hiker, said index finger harness loop inserted over the thumb, said thumb harness loop inserted over the index finger and the said flexible elastic cord member tightened over the wrist of the bare hand of the user to hold the said base structure member and the mirror member with the convex reflective upper surface flat on the back of the bare hand of the user over the optimum sweet spot triangulated area between the index finger, thumb and wrist of the hand.

5. The apparatus as in claim 1 wherein said wrist harness loop is inserted over the wrist of the gloved left hand of a bicycle rider, other personal mobility vehicle rider, or a pedestrian such as a walker, runner, hiker, said index finger harness loop inserted over the gloved index finger, said thumb harness loop inserted over the gloved thumb and the said flexible elastic cord member tightened over the wrist of the gloved hand of a user to hold the said base structure member and the mirror member with the convex reflective upper surface flat on the back of the gloved hand of the user over the optimum sweet spot triangulated area between the index finger, thumb and wrist of the hand.

6. The apparatus as in claim 1 wherein said wrist harness loop is inserted over the wrist of the gloved right hand of a bicycle rider, other personal mobility vehicle rider, or a pedestrian such as a walker, runner, hiker, said index finger harness loop inserted over the gloved thumb, said thumb harness loop inserted over the gloved index finger and the said flexible elastic cord member tightened over the wrist of the gloved hand of a user to hold the said base structure member and the mirror member with the convex reflective upper surface flat on the back of the gloved hand of the user over the optimum sweet spot triangulated area between the index finger, thumb and wrist of the hand

7. The apparatus as in claim 1 wherein the apparatus can be adjusted through the said flexible elastic cord member to be worn on any size bare hand.

8. The apparatus as in claim 1 wherein the apparatus can be adjusted through the said flexible elastic cord member to be worn on any size gloved hand.

9. The apparatus as in claim 1 wherein the said mirror member having a convex reflective upper surface provides a clear vibration-free rear view for the rider of a bicycle or other personal mobility vehicle on both a smooth and rough road surface.

10. The apparatus as in claim 1 wherein the apparatus provides easy auto reflex focus and less eye strain for the rider when using the apparatus.

11. The apparatus as in claim 1 wherein said convex reflective mirror is made of high optic scratch resistant lens with sun glare and lens protective shielding.

12. The apparatus as in claim 1 wherein the said mirror member is securely held in place in a press fit relationship on the said base structure member by other integrating means besides the use of adhesives.

13. The apparatus as in claim 1 wherein the apparatus is produced in a variety of colors, replaceable interchangeable reflective mirror elements, new clasping mechanisms and accoutrements to enhance the device's performance and aesthetic appeal.
